(19) United States
(12) Patent Application Publication
(10) Pub. No.: US 2009/0182794 A1
(43) Pub. Date: Jul. 16, 2009

(54) ERROR MANAGEMENT APPARATUS

(75) Inventor: Atsuji Sekiguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/273,904

(22) Filed: Nov. 19, 2008

(30) Foreign Application Priority Data
Jan. 15, 2008 (JP) 2008-006036

(51) Int. Cl. G06F 11/07; G06F 17/30

(52) U.S. Cl. 707/206; 714/39; 707/E17.005; 714/E11.029

(57) ABSTRACT

A recording medium records an error management program for managing an error generated in an apparatus causes a computer to determine whether the error generated in the apparatus is a known error for which an action to cope with has been established. When the error generated in the apparatus is not determined to be a known error, the error is sorted as a new unknown error, and correlation of the new unknown error with an existing unknown error which has been determined to be an unknown error in the past is determined. When correlation of the new unknown error with the existing unknown error is found, new unknown error and the existing unknown error are classified into one group. Action priority of the classified unknown error group is determined; and the unknown error group for which the action priority has been determined is registered in an unknown error pool database.

### CROSS-REFERENCE TO RELATED APPLICATIONS

This application is based upon and claims the benefit of priority of prior Japanese Patent Application No. 2008-006036, filed on Jan. 15, 2008, the entire contents of which are incorporated herein by reference.

### FIELD

The present invention relates to a recording medium recording an error management program for managing an error generated in a target apparatus, an error management apparatus, and an error management method.

### BACKGROUND

Actions to be taken by a maintenance and management person in the event of an incident in a customer's computer system are summarized below. Herein, the term “incident” means a problem that reduces or may possibly reduce quality of service provided by the computer system (hereinafter referred to also as an “error” in some cases).

If an action to cope with (or handle) the incident is known, the known action is executed to remove the incident. If an action to cope with the incident is unknown, the cause of the incident is tracked down to establish the action to cope with the incident, and the established action is executed to resolve the incident. With respect to the incident for which the action has been established, it is preferable to efficiently cope with the problem by reusing the established action when the same type of incident is generated at another time.

One example of the above-described procedure is an incident management process called ITIL v2 (Information Technology Infrastructure Library version 2, i.e., guidelines prepared by the British Government for operation and management of computer systems). That incident management process is performed in a flow of steps of reporting an incident, investigating the past cases, investigating and planning an action to cope with the incident, executing the action, and closing the incident.

The term “incident” is in conformity with ITIL. According to ITIL, the “incident for which a workaround, an alternative action, and an established action are already found” is called a “KE” (Known Error). In the following description, terms are used in conformity with ITIL and the incident other than the known error is called a “UE” (Unknown Error).

In operation and management fields of ICT (Information and Communication Technology), the technology has become even more complicated and complex with recent technical progress. The problem of security in computer systems has become even more serious. Under such situations, the incidents tend to increase in complexity and to be generated in an increasing number. Accordingly, the time required to cope with the incident is so increased that, during a period of coping with one incident, another incident occurs in not-rare cases. Further, a plurality of incidents are generated due to the same cause in increasing cases.

There is a high possibility that incidents are generated more frequently, in particular, upon some change, e.g., an application of a patch for security. Consider, for example, two unknown errors A and B. Also assume that the cause of the unknown error A, for which an action to cope with has been started, is the same as a cause of the unknown error B generated later.

When those two unknown errors A and B are handled as different “unknown errors” in spite of having the same cause, the finding obtained with the unknown error A cannot be utilized for the unknown error B and subsequent similar ones, until an action to cope with the unknown error A is established. Here, the term “established” means that a solution has been found, it has been applied to the unknown error, and the result has been obtained to the customer's satisfaction with confirmation. Upon the action and result being established, the incident is closed.

When the errors A and B are processed as separate “unknown errors” in parallel, whether the action to cope with the unknown error is effective cannot be confirmed until the incident is closed. This may lead to a possibility that investigation for the same reason is repeated and efforts are wastefully performed.

On the other hand, when the unknown errors A and B are processed successively, multiple investigations for the same cause can be avoided, but a longer time is taken for the investigations if the causes of those errors are not the same. In other words, a resolution time is prolonged because coping with the error B is only started after the incident caused by the error A has been closed. Thus, it is apparent that the resolution time is further prolonged as the number of incidents increases.

With the related art, as described above, efficient processing cannot be achieved because of not taking into account a situation that, during a period of coping with one unknown error, another unknown error is generated by the same cause. In view of such a situation, an error information management system is proposed in which the influence of an error is estimated by assigning different degrees of priority to plural items of error information, and the correlation between the error information having the maximum priority and another error information is analyzed to identify the error information to which the cause of the error corresponds, thereby increasing efficiency in coping with the error.

However, the above-described error information management system is intended to specify which one of plural known errors is a root cause, and it does not take unknown errors into consideration. Therefore, when, during a period of coping with one unknown error, another unknown error is generated by the same cause, those two errors are separately handled and efficiency is not increased.

### SUMMARY

According to an aspect of an embodiment, a recording medium recording an error management program for managing an error generated in an apparatus, the error management program causing a computer to execute procedures including: determining whether the error generated in the apparatus is a known error for which an action to cope with is established; when the error generated in the apparatus is not determined to be a known error, sorting the error as a new unknown error and correlating the new unknown error with an existing unknown error which has been determined to be an unknown error in the past; when the presence of the correlation of the new unknown error with the existing unknown error is determined, classifying the new unknown error and the existing unknown error into one group; deciding action priority of the classified unknown error group; and registering, in an unknown error pool database, the unknown error group for which the action priority has been decided.

### BRIEF DESCRIPTION OF THE DRAWINGS

FIG. 1 illustrates an outline of an embodiment;

FIG. 2 is a functional block diagram showing a configuration of an error management apparatus;

FIG. 3 illustrates an example of an incident information table;

FIG. 4 illustrates an example of a known error determination table;

FIG. 5 illustrates an example of a known error pool table;

FIG. 6 illustrates an example of an incident grouping table;

FIG. 7 illustrates an example of an action priority determination table;

FIG. 8 illustrates an example of an unknown error pool table;

FIG. 9 is a flowchart showing procedures of an unknown error registration process; and

FIG. 10 is a flowchart showing procedures of unknown error action post-processing.

### DESCRIPTION OF THE PREFERRED EMBODIMENTS

An embodiment will be described in detail below with reference to the drawings. While the following description is made by taking a server providing various kinds of services as an example of a target apparatus for error management, the target apparatus is not limited to the server, and embodiments can be generally applied to a wide variety of electronic equipment possibly outputting error information.

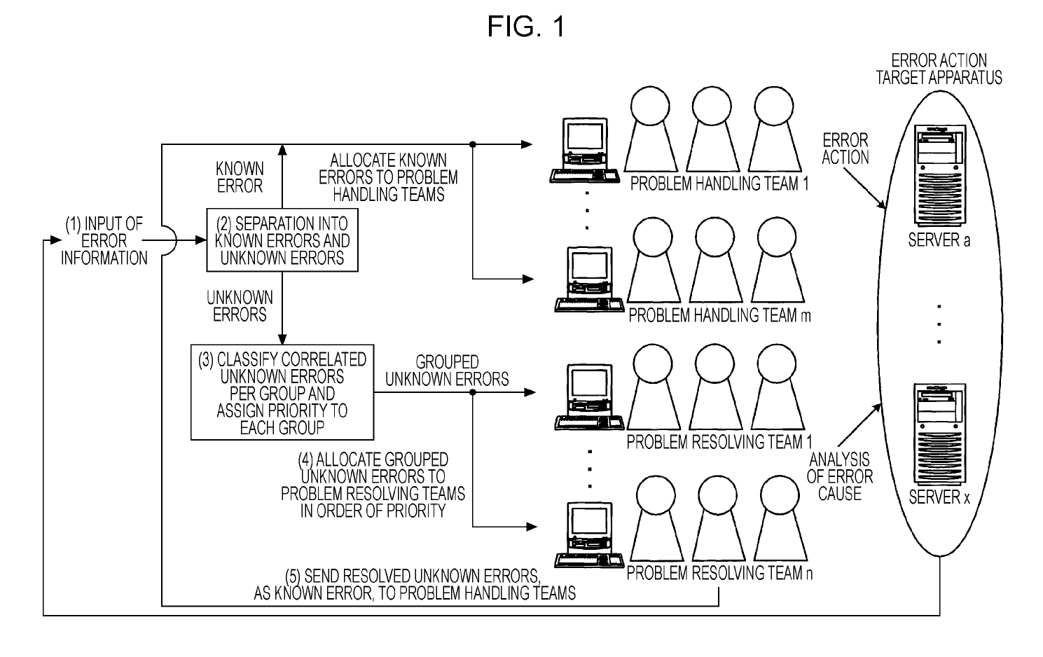

An outline of the embodiment is first described. FIG. 1 illustrates the outline of the embodiment. In an error management apparatus, as indicated by (1) in FIG. 1, error information output from a server a, . . . and a server x, which are each an error action target apparatus, is input to the error management apparatus. Then, as indicated by (2), the error management apparatus separates the input error information into unknown errors for each of which an action to cope with is not established, and known errors for each of which an action to cope with is established.

The error management apparatus allocates the separated known errors to problem handling teams. The problem handling team executes the action to cope with the known error by utilizing the known technique that is already established. On the other hand, as indicated by (3), the error management apparatus classifies the separated unknown errors into groups on the basis of correlation with the existing unknown errors which have been determined as unknown errors in the past, and assigns action priority to each of the groups.

Subsequently, as indicated by (4), the error management apparatus allocates the grouped unknown errors to problem resolving teams depending on the action priority of each unknown error group. The problem resolving team investigates various logs and setting files of a server where the error has occurred, specifies the cause, and establishes an action to cope with the error.

Further, as indicated by (5), the unknown errors for which the actions to cope with have been established by the problem resolving teams are sent, as known errors, to the problem handling teams along with the established actions. Each of the unknown errors for which the action to cope with has been established by the problem resolving team is finally resolved by the problem handling team that executes the action established by the problem resolving team. Note that one person may be engaged in both the problem handling team and the problem resolving team.

By grouping the unknown errors on the basis of the correlation as described above, the unknown errors which are estimated to result from the same cause are classified into one group and are allocated to one problem resolving team. It is therefore possible to avoid such wasteful efforts as having a plurality of problem resolving teams try to specify the causes of the unknown errors in a redundant manner, because the errors have the same cause.

Also, the unknown errors which are estimated to have the same cause are classified into the same group, and the unknown errors which are estimated to have different causes are classified into different groups. Thus, by allocating the unknown errors to the plurality of the problem resolving teams for each group of the unknown errors, the causes of the unknown errors in different groups can be addressed in parallel without redundancy, and efforts of resolving all of the problems can be performed efficiently.

Further, by allocating the groups of the unknown errors to the plurality of problem resolving teams in the order of action priority, the unknown errors with high priority can be resolved with quicker urgency and higher importance.

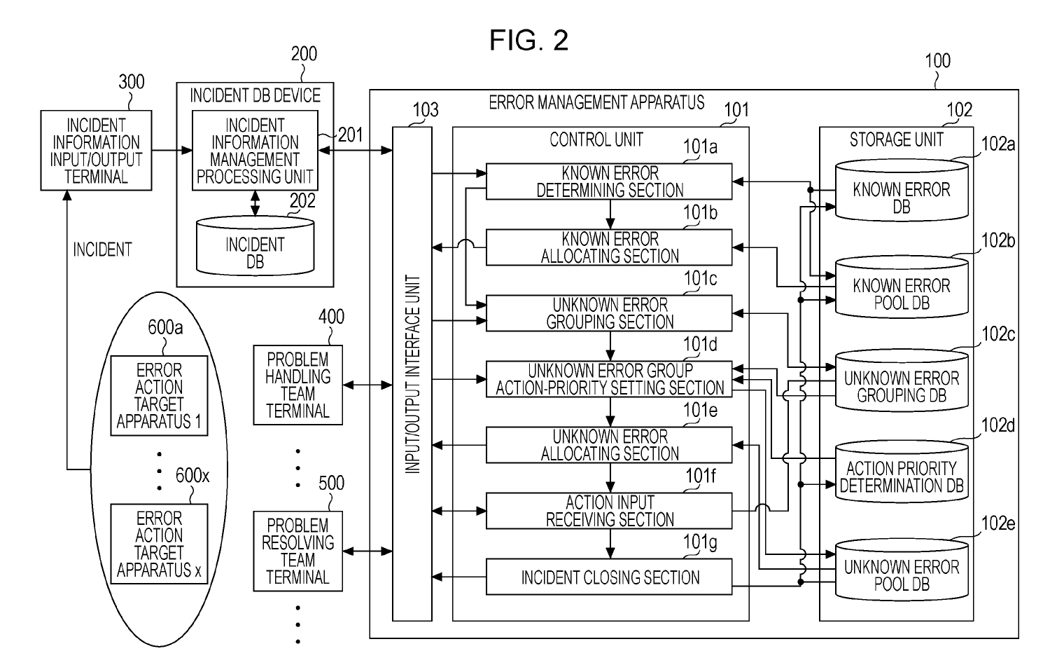

The configuration of the error management apparatus will be described below. FIG. 2 is a functional block diagram showing the configuration of the error management apparatus. As shown in FIG. 2, an error management apparatus 100 according to the embodiment is connected to the following devices in a communicable manner:

An incident DB (Database) device 200 for managing incident information that is issued by reporting information regarding an incident.

A problem handling team terminal 400 serving as an interface for the problem handling team which applies the established action to the error action target apparatus having generated the error, and resolves the problem.

A problem resolving team terminal 500 serving as an interface for the problem resolving team which uncovers the cause of the error, and establishes the action needed to cope with the error.

Multiple problem handling team terminals 400 and problem resolving team terminals 500 may be installed, though not shown, corresponding to the plurality of problem handling teams and the plurality of problem resolving teams, respectively.

The incident DB device 200 is connected in a communicable manner to an incident information input/output terminal 300 for inputting and outputting the incident information that is managed by the incident DB device 200.

In accordance with incidents output from error action target apparatuses 600a, . . . 600x, the incident information is added to an incident DB 202 by an operator who operates the incident information input/output terminal 300. The incident DB device 200 includes an incident information management processing unit 201, which serves a database management system, and the incident DB 202.

If the incidents output from the error action target apparatuses 600a, . . . 600x are new ones, the incident information management processing unit 201 produces a new entry of incident information for each incident in response to input of the generated error phenomenon, the system configuration in which the error has generated, etc. from the incident information input/output terminal 300. Further, the incident information management processing unit 201 sends an incident ID of the new entry (i.e., information for uniquely identifying each incident), the generated error phenomenon, the system configuration, etc. to the error management apparatus 100.

On the other hand, if the incidents output from the error action target apparatuses 600a, . . . 600x are existing ones, the incident information management processing unit 201 adds information of those incidents to the entry of existing incident information in response to an operation made at the incident information input/output terminal 300.

The incident information management processing unit 201 adds the incident information output from the error management apparatus 100 to the entry of the corresponding incident information that is stored in the incident DB 202. Further, the incident information management processing unit 201 manages the status of the incident information (i.e., the situation in coping with the incident).

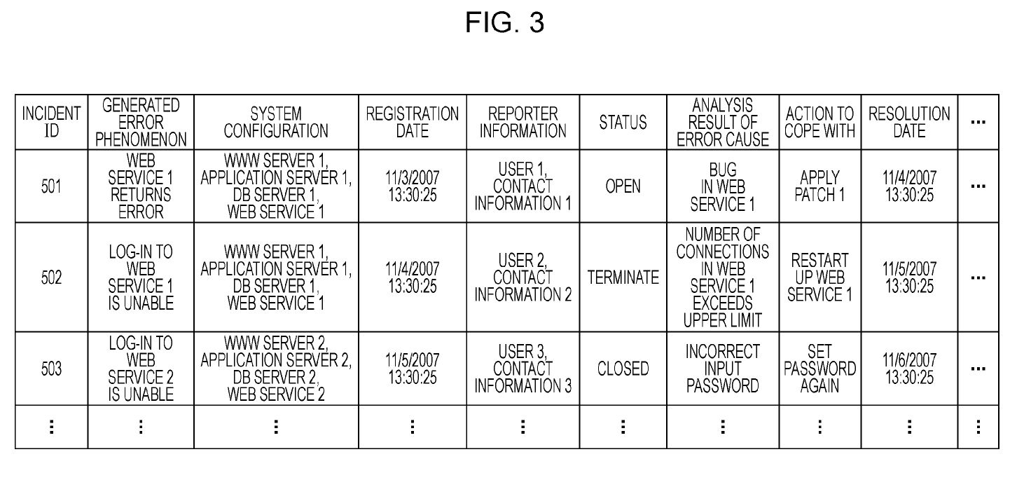

The incident DB 202 stores an incident information table illustrated, by way of example, in FIG. 3. The incident information table has at least columns of “incident ID”, “generated error phenomenon”, “system configuration”, “registration date”, “reporter information”, “status”, “analysis result of error cause”, “action to cope with”, and “resolution date”.

The “incident ID” provides information for uniquely identifying the entry of the relevant incident information. The “generated error phenomenon” means the phenomenon of the error which has been generated in the error action target apparatus. The “system configuration” means the hardware and software configurations of the error action target apparatus in which the error has been generated. The “registration date” means the date when the entry of the relevant incident information has been registered.

The “reporter information” represents the ID information and the contact information of a reporter who has reported the relevant incident information. The “status” means the situation in coping with the relevant incident information. For example, if the action to cope with is not yet established, “open” is set as the “status”. If the “open” status is pending for too long, “terminate” is set as the “status”. If the action to cope with is established, “closed” is set as the “status”.

The “analysis result of error cause” represents the cause of the error which has been specified by the problem resolving team and input through the problem resolving team terminal 500. The “action to cope with” means the action to cope with the error, as established by the problem resolving team and input through the problem resolving team terminal 500. The “resolution date” means the date when the action to cope with the error has been established and the “action to cope with” has been added to the incident information.

The error management apparatus 100 includes a control unit 101, a storage unit 102, the incident DB device 200, and an input/output interface unit 103 serving as a communication interface which performs communication with the problem handling team terminal 400 and the problem resolving team terminal 500.

The control unit 101 is a control device, such as a microcomputer, for executing entire control of the error management apparatus 100. As components closely related to the embodiment, the control unit 101 includes a known error determining section 101a, a known error allocating section 101b, an unknown error grouping section 101c, an unknown error group action-priority setting section 101d, an unknown error allocating section 101e, an action input receiving section 101f, and an incident closing section 101g.

The known error determining section 101a determines, by searching a known error DB 102a described later, whether incident information input from the incident DB device 200, including a new incident ID, the generated error phenomenon, the system configuration, etc., corresponds to any known error.

If the known error determining section 101a determines that the new incident information input from the incident DB device 200 is known, the new incident information is registered as the known error in a known error pool DB 102b described later.

The known error allocating section 101b transmits each of the known errors registered in the known error pool DB 102b to one of the problem handling team terminals 400 for the problem handling teams so that the known errors are allocated to the problem handling teams in accordance with a predetermined rule. Upon confirming the contents of the known error at the problem handling team terminal 400, the problem handling team applies the established action to the corresponding error action target apparatus and executes the action to cope with the known error.

If the known error determining section 101a determines that the new incident information input from the incident DB device 200 is not known, the new incident information is classified, as an unknown error, into one of the groups by the unknown error grouping section 101c.

More specifically, on the assumption that the incident information matching in the generated error phenomenon, the system configuration, etc. results from the same cause, the unknown error grouping section 101c searches an unknown error grouping DB 102c and adds the new incident information to the unknown error group that matches the generated error phenomenon, the system configuration, etc.

If the unknown error group matching in the generated error phenomenon, the system configuration, etc. is not found as a result of searching the unknown error grouping DB 102c, the unknown error grouping section 101c newly prepares an unknown error group and adds the new incident information to the new unknown error group.

After the new incident information has been added to the unknown error grouping DB 102c by the unknown error grouping section 101c, the unknown error group action-priority setting section 101d searches an action priority determination DB 102d described later and sets priority for each of the unknown error groups registered in the unknown error grouping DB 102c.

After setting the priority for each of the unknown error groups, the unknown error group action-priority setting section 101d updates respective entries of those unknown error groups registered in the unknown error pool DB 102e described later, to which the new incident information has been added and for which the priority has been changed, and further adds an entry of the newly prepared unknown error group to the unknown error pool DB 102e.

The unknown error allocating section 101e takes out the unknown error groups, which are registered in the unknown error pool DB 102e in the order of the action priority set by the unknown error group action-priority setting section 101d, and it transmits each of the taken-out unknown error groups to one of the problem resolving team terminals 500 for the problem resolving teams. Upon confirming the contents of the unknown error at the problem resolving team terminal 500, the problem resolving team specifies the cause of the unknown error in the corresponding error action target apparatus, establishes an action to cope with the unknown error, and calculates the man-hours likely required for the action.

The man-hours required for the action is one example of an index representing a degree of importance of the relevant error. The index is not limited to man-hours and another suitable parameter may also be used so long as it can represent the importance or the influence of the relevant error, including the extent or degree of influence of the error, the resulting damages, etc.

After specifying the cause of the unknown error and establishing the action to cope with the unknown error, the problem resolving team outputs the cause of the unknown error and the established action through the problem resolving team terminal 500 for transmission to the error management apparatus 100. The action input receiving section 101f of the error management apparatus 100 receives the cause of the unknown error and the established action, both transmitted through the problem resolving team terminal 500, and it adds them to the incident information of the corresponding unknown error group, which is registered in the unknown error grouping DB 102c.

The incident closing section 101g instructs the incident DB device 200 to close the incident information of the unknown error for which the cause has been specified and the action has been established. Also, the incident closing section 101g updates the action priority set in the action priority determination table in the action priority determination DB 102d depending on the man-hours required for the action.

Further, if the causes of all the unknown errors in the same unknown error group have been specified and the actions to cope with those unknown errors have been established, the incident closing section 101g deletes the entry of the corresponding relevant unknown error group from the unknown error grouping DB 102c.

In addition, the incident closing section 101g moves, from the unknown error pool DB 102e to the known error pool DB 102b, the entry of the unknown error group for which the causes of all the unknown errors therein have been specified and the actions to cope with those unknown errors have been established. Moreover, the incident closing section 101g extracts, from the unknown error pool DB 102e, the generated error phenomena, the system configurations, and the incident IDs in the unknown error group for which the causes of all the unknown errors therein have been specified and the actions to cope with those unknown errors have been established, and then registers them in the known error DB 102a.

The storage unit 102 is a storage device constituting databases (DBs). More specifically, the storage unit 102 includes the known error DB 102a, the known error pool DB 102b, the unknown error grouping DB 102c, the action priority determination DB 102d, and the unknown error pool DB 102e.

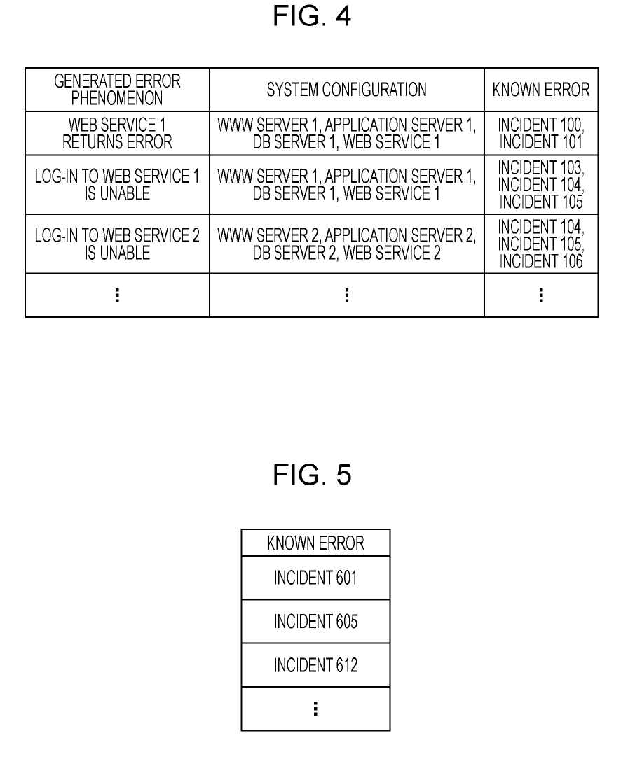

The known error DB 102a stores a known error determination table illustrated, by way of example, in FIG. 4. The known error determination table has at least columns of “generated error phenomenon”, “system configuration”, and “known error”. The “generated error phenomenon” means the phenomenon of the error which has been generated in the error action target apparatus and which is included in the incident information. The “system configuration” means the hardware and software configurations of the error action target apparatus in which the error has been generated. The “known error” represents the information for uniquely identifying the incident information for which the action to cope with the error has been established.

The known error pool DB 102b stores a known error pool table illustrated, by way of example, in FIG. 5. The known error pool table is a list of incident IDs of the known errors, the list having a column of “known error”. The incident information having the incident ID registered in the list corresponds to the known error.

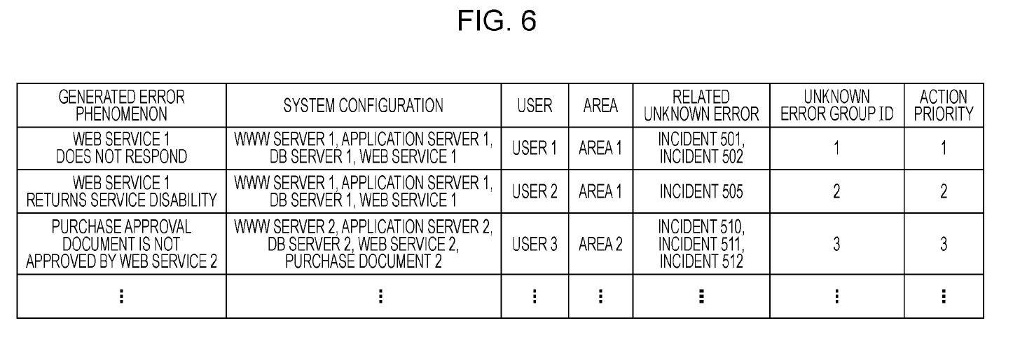

The unknown error grouping DB 102c stores an unknown error (incident) grouping table illustrated, by way of example, in FIG. 6. The unknown error grouping table has an entry of the unknown error group and also has at least columns of “generated error phenomenon”, “system configuration”, “user”, “area”, “related unknown error”, “unknown error group ID”, and “action priority”. The “generated error phenomenon” column means the phenomenon of the error which has generated in the error action target apparatus and which is included in the incident information.

The “system configuration” column means the hardware and software configurations of the error action target apparatus in which the error has been generated. The “user” column represents the ID information of a reporter who has reported the relevant incident information. The “area” column provides information regarding an area where the error action target apparatus that caused the error corresponding to the relevant incident information is installed. Note that the “user” and the “area” information may both be stored in one entry.

The “related unknown error” stores respective incident IDs of sets of the incident information, which have the same “generated error phenomenon” and the same “system configuration”. The “unknown error group ID” represents ID information for uniquely identifying the unknown error group of the relevant incident information. The “action priority” means the action priority of the unknown error group.

Thus, by employing the unknown error grouping table, the sets of the incident information, which have the same “generated error phenomenon” and the same “system configuration”, are classified into the same group. In other words, if the “generated error phenomenon” and the “system configuration” are the same, this results in a high possibility that the cause of the error and the action to cope with the error are also the same. By allocating the unknown errors to the problem resolving teams in units of unknown error groups, therefore, it is possible to avoid wasteful efforts such as a plurality of problem resolving teams specifying the causes of the unknown errors and establishing the actions to cope with the unknown errors in a redundant manner. Also, the plurality of problem resolving teams can perform work of coping with different unknown error groups in parallel.

In addition, because the action priority is set for each unknown error group in the unknown error grouping table, a possibility of resolving the unknown errors at earlier timing, which have quicker urgency and higher importance, can be increased by coping with the unknown error groups in the order of action priority.

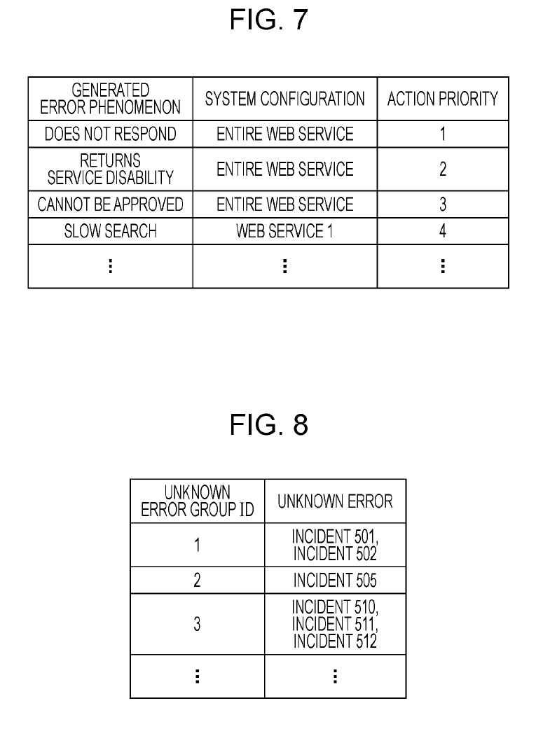

The action priority determination DB 102d stores an action priority determination table illustrated, by way of example, in FIG. 7. The action priority determination table has at least columns of “generated error phenomenon”, “system configuration”, and “action priority”. If at least one of the “generated error phenomenon” and the “system configuration” in the unknown error (incident) grouping table matches with the “generated error phenomenon” and the “system configuration” in the action priority determination table, the corresponding action priority is set in the column of “action priority” in the unknown error grouping table.

The unknown error pool DB 102e stores an unknown error pool table illustrated, by way of example, in FIG. 8. The unknown error pool table has a list of incident IDs of the unknown errors, the list having columns of “unknown error group ID” and “unknown error”. The “unknown error group ID” represents ID information for uniquely identifying the unknown error group of the relevant incident information. The “unknown error” represents an incident ID corresponding to the unknown error. The incident information having the incident ID registered in the list corresponds to the unknown error.

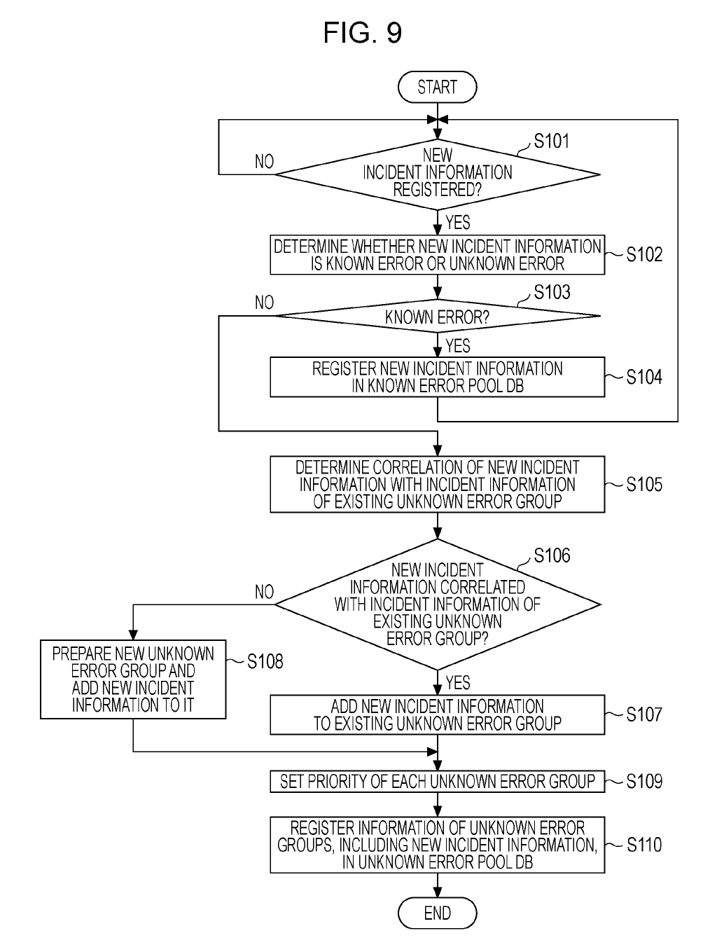

An unknown error registration process executed by the error management apparatus 100 according to the embodiment will be described below. FIG. 9 is a flowchart showing procedures of the unknown error registration process. As shown in FIG. 9, the known error determining section 101a first determines whether registration of new incident information into the incident DB 202 has occurred (step S101).

If it is determined that registration of new incident information into the incident DB 202 has occurred (Yes in step S101), the processing shifts to step S102. If it is not determined that registration of new incident information into the incident DB 202 has occurred (No in step S101) step S101 is repeated.

In step S102, the known error determining section 101a determines, by referring to the known error determination table in the known error DB 102a, whether the new incident information is a known error or an unknown error.

If the determination result in step S102 indicates that the new incident information is a known error (Yes in step S103), the processing shifts to step S104. If the determination result in step S102 indicates that the new incident information is an unknown error (No in step S103) the processing shifts to step S105. In step S104, the known error determining section 101a adds the new incident information to the known error pool table in the known error pool DB 102b.

In step S105, the unknown error grouping section 101c determines, by referring to the unknown error grouping table in the unknown error grouping DB 102c, whether there is an unknown error group matching in the “generated error phenomenon” and the “system configuration” columns with the new incident information. If there is an unknown error group matching in the “generated error phenomenon” and the “system configuration” with the new incident information (Yes in step S106), the incident ID of the new incident information is added to the relevant unknown error group (step S107). If step S107 is completed, the processing shifts to step S109.

If examination of the unknown error grouping table in the unknown error grouping DB 102c finds no unknown error group matching in the “generated error phenomenon” and the “system configuration” categories with the new incident information (No in step S106), the unknown error grouping section 101c prepares a new unknown error group and adds the incident ID of the new incident information to the new unknown error group (step S108). If step S108 is completed, the processing shifts to step S109.

In step S109, the unknown error group action-priority setting section 101d refers to the action priority determination table in the action priority determination DB 102d, and if at least one of the “generated error phenomenon” and the “system configuration” in the unknown error grouping table matches with the “generated error phenomenon” and the “system configuration” in the action priority determination table, the setting section 101d sets the corresponding action priority in the column of “action priority” in the unknown error (incident) grouping table.

Further, the unknown error group action-priority setting section 101d sets the priority for each unknown error group. Thereafter, the unknown error group action-priority setting section 101d updates the respective entries of each unknown error group to which the new incident information has been added and of each unknown error group of which priority has been changed, among the existing unknown error groups registered in the unknown error pool table in the unknown error pool DB 102e. Moreover, the unknown error group action-priority setting section 101d adds the entry of the newly prepared unknown error group to the unknown error pool DB 102e (step S110).

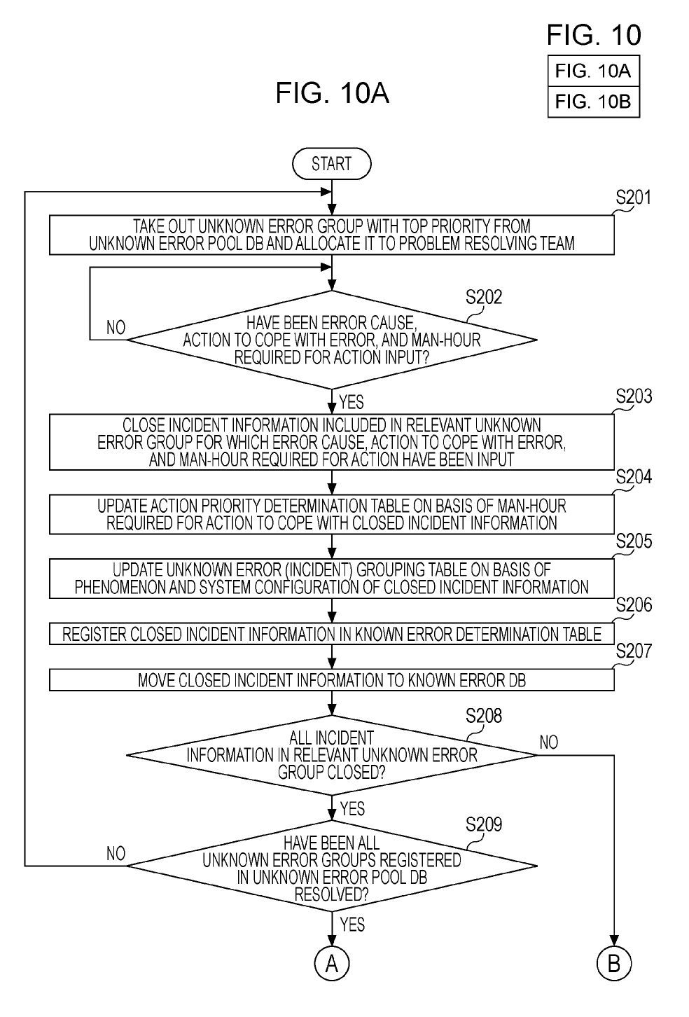

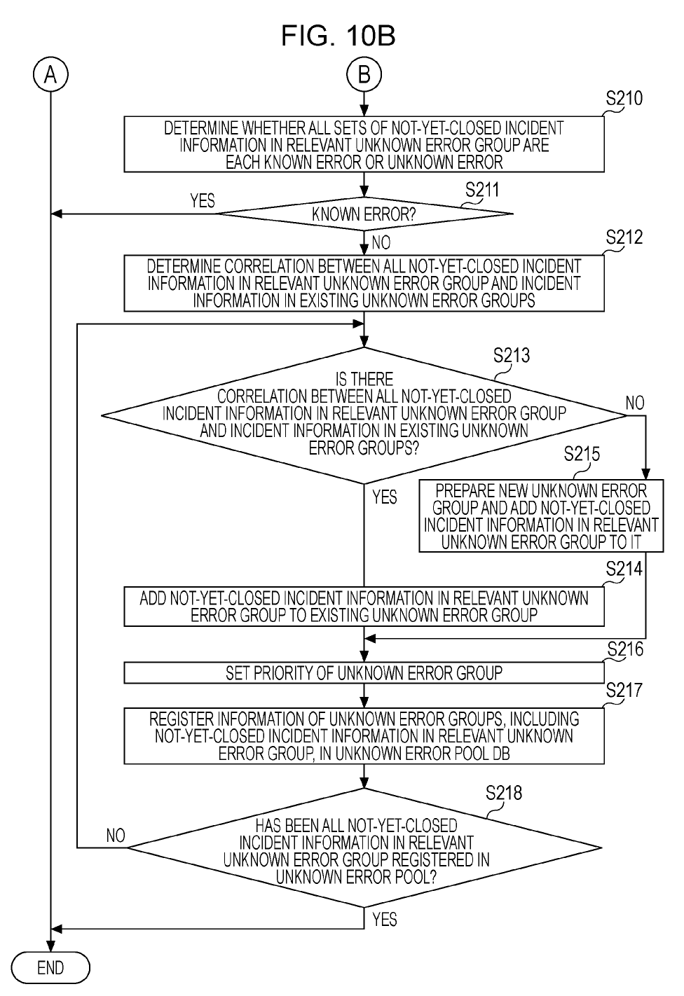

Unknown error action post-processing executed in the error management apparatus 100 according to the embodiment will be described below. FIG. 10 is a flowchart showing procedures for unknown error action post-processing. As shown in FIG. 10, first, the unknown error allocating section 101e takes out the unknown error groups, which are registered in the unknown error pool table in the unknown error pool DB 102e, in the order of the action priority set by the unknown error group action-priority setting section 101d, and it transmits each of the taken-out unknown error groups to one of the problem resolving team terminals 500 for the problem resolving teams so that the unknown error groups are allocated to the corresponding problem handling teams (step S201). Upon confirming the contents of the unknown error at the problem resolving team terminal 500, the problem resolving team specifies the cause of the unknown error in the corresponding error action target apparatus, establishes an action to cope with the unknown error, and calculates the man-hours required for the action.

Then, the action input receiving section 101f determines whether the cause of the unknown error in the corresponding error action target apparatus, the action to cope with the unknown error, and the man-hours required for the action are input (step S202). If section 101f determines that the cause of the unknown error in the corresponding error action target apparatus, the action to cope with the unknown error, and the man-hours required for the action have been input (Yes in step S202), the processing shifts to step S203. If the section 101f does not determine that the cause of the unknown error in the corresponding error action target apparatus, the action to cope with the unknown error, and the man-hours required for the action are input (No in step S202), the processing of step S202 is repeated.

Then, the incident closing section 101g closes the incident information for which the relevant unknown error group for which the error cause, the action to cope with, and the required man-hours have been input (step S203). Further, the incident closing section 101g updates the action priority in the action priority determination table on the basis of the man-hours required for the action to cope with the closed incident information (step S204).

Then, the incident closing section 101g updates the unknown error (incident) grouping table in the unknown error grouping DB 102c on the basis of the phenomenon and the system configuration regarding the closed incident information. More specifically, the incident closing section 101g adds the error cause and the action to cope with, which have been transmitted through the problem resolving team terminal 500, to the incident information of the corresponding unknown error group registered in the unknown error grouping DB 102c (step S205).

Then, the incident closing section 101g registers the closed incident information in the known error determination table in the known error DB 102a (step S206). Further, the incident closing section 101g moves the closed incident information from the unknown error pool DB 102e to the known error pool DB 102b (step S207).

Then, the incident closing section 101g determines whether all the incident information in the relevant unknown error group has been closed (step S208). If the section 101g determines that all the incident information in the relevant unknown error group has been closed (Yes in step S208), the processing shifts to step S209. If the section 101g does not determine that all the incident information in the relevant unknown error group has been closed (No in step S208), the processing shifts to step S210.

In step S209, it is determined whether all the unknown error groups registered in the unknown error pool DB 102e have been resolved. If it is determined that all the unknown error groups registered in the unknown error pool DB 102e have been resolved (Yes in step S209), the unknown error action post-processing is brought to an end. If it is determined that all the unknown error groups registered in the unknown error pool DB 102e have not been resolved (No in step S209), the processing shifts to step S201.

On the other hand, in step S210, the known error determining section 101a determines again whether all the sets of not-yet-closed incident information in the relevant unknown error group are each a known error or an unknown error. If the determination result in step S210 indicates that all the sets of incident information are known errors (Yes in step S211), the unknown error action post-processing is brought to an end.

If any of the sets of incident information is determined to be an unknown error (No in step S211), the processing shifts to step S212. In step S212, the unknown error grouping section 101c determines the correlation between each of all the sets of the not-yet-closed incident information in the relevant unknown error group and the incident information in the existing unknown error groups (step S212).

If the determination result indicates correlation between the not-yet-closed incident information in the relevant unknown error group and the incident information in the existing unknown error group (Yes in step S213), the processing shifts to step S214. If the determination result does not indicate correlation between the not-yet-closed incident information in the relevant unknown error group and the incident information in the existing unknown error group (No in step S213), the processing shifts to step S215.

In step S214, the unknown error grouping section 101c adds the not-yet-closed incident information in the relevant unknown error group to the existing unknown error group in the unknown error grouping table in the unknown error grouping DB 102c.

Then, the unknown error group action-priority setting section 101d sets priority of the relevant unknown error group (step S216). On the other hand, in step S215, the unknown error grouping section 101c prepares a new unknown error group and adds the not-yet-closed incident information in the relevant unknown error group to the new unknown error group. If step S215 is completed, the processing shifts to step S216.

Then, the unknown error group action-priority setting section 101d registers, in the unknown error pool DB 102e, the information of the unknown error groups, including the not-yet-closed incident information, in the relevant unknown error group (step S217). Further, the unknown error group action-priority setting section 101d determines whether all the not-yet-closed incident information in the relevant unknown error group has been registered in the unknown error pool DB 102e (step S218).

If the section 101d determines that all the not-yet-closed incident information in the relevant unknown error group has been registered in the unknown error pool DB 102e (Yes in step S218), the unknown error action post-processing is brought to an end. If the section 101d does not determine that all the not-yet-closed incident information in the relevant unknown error group has been registered in the unknown error pool DB 102e (No in step S218), the processing shifts to step S213.

The purpose of executing the processing subsequent to step S201 is as follows. When the incident information of some unknown error is closed, there is a possibility that several unknown errors in the unknown error pool DB have become known errors. Also, there is a possibility that the action priority has changed. For those reasons, the unknown errors in the unknown error pool DB are sent to the unknown error determining section 101a for executing the unknown error determination again. As a result, the errors having become known are no longer present in the unknown error pool DB, and the action priority is reappraised so that the problem resolving team can always start with the most important error.

According to the above-described embodiment, even when a plurality of unknown errors are generated for which actions to cope with are not established, those unknown errors can be coped with out investigating them in a redundant manner, and unknown errors probably resulting from uncorrelated causes can be coped with in parallel.

More specifically, since the unknown errors probably resulting from the same cause are classified into one group and only one of the unknown errors belonging to the one group is coped with at one time, redundancy in investigating respective causes of the unknown errors resulting from the same cause can be reduced. Also, because of a low possibility that the unknown errors belonging to different groups result from the same cause, those unknown errors can be coped with in parallel.

Further, advantageously, when an action to cope with some unknown error is established, the remaining unknown error(s) in the same group are preferentially coped with from that time. As a result, the important unknown errors can be efficiently coped with by cutting the time required to establish the actions needed to cope with the individual unknown errors.

While the embodiment of the present invention has been described above, the present invention is not limited to the above-described embodiment and may also be implemented in other various embodiments. Further, advantages of the present invention are not limited to those ones described above in the embodiment.

The known error determination table is not necessarily required. The incident DB 202 registering the incident information therein may be searched to determine whether the incident information is a known error. For increasing efficiency of the search, the known error determination may be performed by using data in a tree structure, e.g., a Fault Tree, instead of the known error determination table.

When the unknown error grouping table is revised each time an unknown error is newly registered in the unknown error pool DB, the unknown error grouping table may be revised in part instead of the whole thereof. Also, when the unknown error grouping table is revised each time the incident information of the unknown error is closed, the unknown error grouping table may be revised in part instead of the whole thereof. Further, when the action priority determination table is revised each time the incident information of the unknown error is closed, the action priority determination table may be revised in part instead of the whole thereof.

All or part of the processes in the above-described embodiment, which have been described as being automatically executed, may also be manually executed. Conversely, all or part of the processes in the embodiment, which have been described as being manually executed, may also be automatically executed by using one or more known methods. The processing procedures, the control procedures, the concrete names, and the information including various data and parameters, which are described above in the embodiment, can be optionally changed unless otherwise specified.

The components of each apparatus, etc. described above are illustrated from the functional and conceptual points of view, and they are not necessarily required to be constituted as illustrated from the physical point of view. In other words, the distributed or integrated form of the components of each apparatus or device is not limited to the illustrated one, and those components may be entirely or partially distributed or integrated in arbitrary units from the functional or physical point of view depending on various loads, situations of use, etc.

The whole or arbitrary part of the processing functions executed by each apparatus or device may be realized with a CPU (Central Processing Unit) or a microcomputer such as an MPU (Micro Processing Unit) or a MCU (Micro Controller Unit) or with programs analyzed and executed by the CPU (or the microcomputer such as the MPU or MCU), or with hardware in the form of wired logic.

1. A recording medium recording an error management program for managing an error generated in an apparatus, the error management program causing a computer to execute procedures comprising:
determining whether the error generated in the apparatus is a known error for which an action to cope with has been established;
when the error generated in the apparatus is not determined to be a known error, sorting the error as a new unknown error and determining correlation of the new unknown error with an existing unknown error which has been determined to be an unknown error in the past;
when the presence of the correlation of the new unknown error with the existing unknown error is found, classifying the new unknown error and the existing unknown error into one group;
deciding action priority of the classified unknown error group; and
registering, in an unknown error pool database, the unknown error group for which the action priority has been decided.

2. The recording medium according to claim 1,
wherein determining whether the error generated in the apparatus is a known error comprises searching, on the basis of a phenomenon of the error generated in the apparatus and a system configuration of the apparatus, a known error determination database which stores ID information of individual existing known errors in a corresponding relation to generated error phenomena and system configurations, thereby determining whether the error generated in the apparatus is the known error for which the action to cope with has been established.

3. The recording medium according to claim 1,
wherein determining correlation of the new unknown error with an existing unknown error comprises searching, on the basis of a phenomenon of the error generated in the apparatus and a system configuration of the apparatus, an unknown error grouping database which stores ID information of individual existing unknown errors in a corresponding relation to generated unknown-error phenomena and system configurations, thereby determining the correlation of the new unknown error generated in the apparatus with the existing unknown error, and
wherein classifying the new unknown error comprises, when the presence of the correlation of the new unknown error with the existing unknown error is found, classifying the new unknown error and the existing unknown error into one group and registering both unknown errors in the unknown error grouping database.

4. The recording medium according to claim 1,
wherein deciding action priority comprises searching, on the basis of a phenomenon of the error generated in the apparatus and a system configuration of the apparatus, an action priority determination database which stores action priorities of individual errors in a corresponding relation to generated error phenomena and system configurations, thereby deciding the action priority of the classified unknown error group, and setting the decided action priority of the classified unknown error group stored in the unknown error grouping database, which stores ID information of individual existing unknown errors, ID information of individual unknown error groups, and action priorities of the individual unknown error groups in a corresponding relation to generated error phenomena and system configurations.

5. The recording medium according to claim 1, the procedures further comprising:
receiving input of an action to cope with the unknown error in the unknown error group, the action being obtained as a result of error cause resolution, and
updating a status of the unknown error, for which the input of the action has been received, to completion of error cause resolution.

6. The recording medium according to claim 5, the procedures further comprising:
when the status of the unknown error is updated to the completion of error cause resolution, registering the unknown error, as a known error, in a known error determination database.

7. The recording medium according to claim 5, the procedures further comprising:
when the status of the unknown error is updated to the completion of error cause resolution, registering information of the unknown error registered in the unknown error pool database, as a known error, in the known error database which registers, as known errors, errors for which actions to cope with are established.

8. The recording medium according to claim 5,
wherein receiving input of an action further includes receiving input of a cost of the action to cope with the unknown error,
the procedures further comprising:
updating the action priority in the action priority determination database on the basis of the action to cope with the unknown error and the action cost.

9. The recording medium according to claim 5, the procedures further comprising:
when the status of the unknown error is updated to the completion of error cause resolution, deleting the ID information of the unknown error from the unknown error grouping database.

10. The recording medium according to claim 5,
wherein determining whether the error generated in the apparatus is a known error comprises, when one unknown error group includes an unknown error of which status has not been updated to the completion of error cause resolution, determining again, for all the unknown errors included in the one unknown error group and having statuses not updated to the completion of error cause resolution, whether each unknown error has become a known error.

11. An error management apparatus comprising:
a known error determination database storing ID information of individual known errors in a corresponding relation to generated error phenomena and system configurations;
an unknown error grouping database storing ID information of individual existing unknown errors in a corresponding relation to generated phenomena of the unknown errors and system configurations;
an action priority determination database storing action priorities of individual errors in a corresponding relation to generated error phenomena and system configurations;
an unknown error pool database registering unknown error groups;
known error determining means for searching the known error determination database and determining whether an error generated in a target apparatus is a known error for which an action to cope with has been established;
unknown error correlation determining means for, when the error generated in the target apparatus is not determined to be a known error by the known error determining means, sorting the error as a new unknown error and determining correlation of the new unknown error with an existing unknown error which has been determined to be an unknown error in the past;
unknown error grouping means for, when the presence of the correlation of the new unknown error with the existing unknown error is determined by the unknown error correlation determining means, classifying the new unknown error and the existing unknown error into one group and registering the one group in the unknown error grouping database;
action priority deciding means for searching the action priority determination database and deciding action priority of the unknown error group which has been classified by the unknown error grouping means and registered in the unknown error grouping database; and
unknown error group registering means for registering, in the unknown error pool database, the unknown error group for which the action priority has been decided by the action priority deciding means.

12. An error management method comprising:
determining whether an error generated in an apparatus is a known error for which an action to cope with has been established;
when the error generated in the apparatus is not determined to be a known error, sorting the error as a new unknown error and determining correlation of the new unknown error with an existing unknown error which has been determined to be an unknown error in the past;
when the presence of the correlation of the new unknown error with the existing unknown error is determined, classifying the new unknown error and the existing unknown error into one group;
deciding action priority of the classified unknown error group; and
registering, in an unknown error pool database, the unknown error group for which the action priority has been decided.
